(19) United States
(12) Patent Application Publication
(10) Pub. No.: US 2006/0110233 A1
(43) Pub. Date: May 25, 2006

(54) Pyromechanical fastening element

(76) Inventors: Uwe Brede, Fuerth (DE); Heinrich Lorenz, Wolfsburg (DE); Henning Jacob, Hankersbuttel (DE); Ulrich Kempe, Braunschweig (DE); Udo Kautz, Lehre (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/530,200

(22) PCT Filed: Sep. 30, 2003
(86) PCT No.: PCT/EP03/10828

§ 371 Date: Dec. 7, 2005

(30) Foreign Application Priority Data
Oct. 2, 2002 (DE) 102 46 028.0
Aug. 21, 2003 (DE) 103 38 394.8

(51) Int. Cl. F16B 13/04

(52) U.S. Cl. 411/20

(57) ABSTRACT

The invention relates to a pyromechanical fastening element for connecting two parts in an unremovable fixed mechanical manner. The invention is characterized by the fact that said fastening element comprises a metallic shell (2), within the head portion (3) of which a pyrotechnical propellant charge (4) that borders an adapter (5) is disposed, while a fastening means for a first part (1a) is disposed adjacent to the adapter (5) on the rear portion of the shell (2). A second part (1b) can be slid between the first part (1a) and the adapter (5). The head portion (3) of the shell (2) is provided with set fracture notches (6) which rip the shell (2) open and make said shell (2) bend around the adapter when the propellant charge (4) is ignited, whereby the first part (1a) is connected in a fixed manner to the second part (1b).

The invention relates to a pyromechanical fastening element for mechanically connecting two structural parts in an unremovable and fixed manner.

When assembling mechanical structural elements, connections are preferably established by means of screws and nuts. Especially in the automobile industry, however, often the parts that are to be connected are in positions that are difficult to access so considerable outlay on devices, robotic screwing arrangements and assembly systems is required.

Substantial progress could be achieved if above all parts whose connection positions are practically inaccessible are provided with fastening elements that can be activated after joining and in consequence of a change in shape bring about jamming, riveting or bracing of the structural parts.

The underlying object of the invention is therefore to develop a pyrotechnically acting fastening element that is deformed or changed after a specific supply of triggering energy in consequence of the pressure build-up of a pyrotechnic explosive charge in such a way that structural parts are connected together in an unremovable and fixed manner.

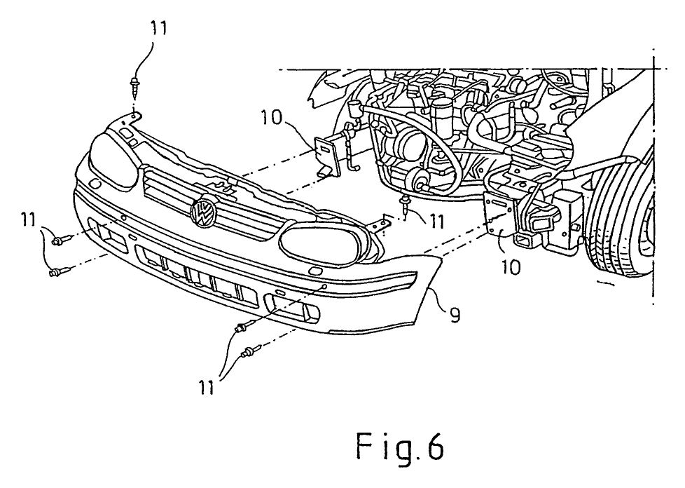

For a better understanding, by way of an example of a front-end bumper module 9 of a motor vehicle FIG. 6 shows the technical assembly problem of the screw connection with screws 11 that is difficult to access.

The completely fitted bumper module 9 here is moved onto the partition plates 10 and screwed with the assistance of robots. This assembly is expensive and time-consuming.

A further object of the invention is to find a fastening element that renders possible without the use of tools a fixed mechanical connection for assembly positions that are difficult to access.

At the same time, the element should be shaped in such a way that on the one hand it can be fixedly pre-assembled on one of the structural elements to be joined and, on the other hand, it permits adjustment of the other structural element.

In accordance with the invention, these objects are achieved by means of the features of claim 1. The invention is distinguished in that the fastening element consists of a metallic shell, arranged in the head portion of which there is a pyrotechnic propellant charge that is adjacent to an adapter and arranged on the rear portion of the shell adjacently to the adapter there is a fastening means for a first structural part, and a second structural part can be slid on between the first structural part and the adapter, with the shell having at its head portion set fracture notches that extend in the longitudinal direction and rip open the shell when the propellant charge is ignited and can be bent around the adapter, thereby fixedly connecting the first structural part to the second structural part.

For the purposes of a search-aid in the case of later use, the head portion of the shell is preferably formed so that it is conical.

The shell of the fastening element is advantageously produced using the deep-drawing process, with the adapter being embedded in the shell with press fit.

For the purposes of simple ignition of the pyrotechnic propellant charge, advantageously the propellant charge can be ignited by means of a punctiform heat source, with the heat source preferably being a laser beam of a laser.

The fastening means for the first structural part is preferably a flanged edge. However, any other kind of fastening can also be used.

In order to be able to connect less exact joint parts as well, advantageously adjacently to the second structural part a floating disc is slid onto the adapter as a counter-bearing.

The invention is described in the following with the aid of exemplary embodiments.

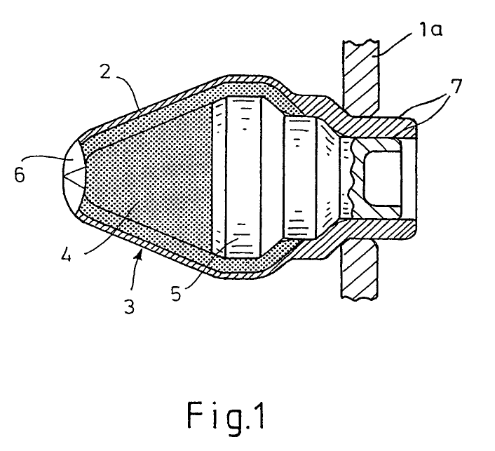

FIG. 1 shows a typical basic solution with regard to achieving the “pyromechanical fastening element” in accordance with the invention.

The pyromechanical fastening element consists of a shell 2 that is produced according to the deep-drawing process with a conical head portion 3 as a search-aid in later use. The shell 2 has set fracture notches 6 that guarantee a specific ripping-open action. The propellant 4 is arranged in the front region. An adapter 5 closes off the charge chamber with a press fit. After loading the propellant 4 and pressing in the adapter 5, the shell 2 is pressed onto the adapter 5 in the rear region in a form-locking manner. The element is thus prepared for pre-assembly on a structural part 1a. A flanged edge 7 is-provided for the purpose of fastening the first structural part 1a.

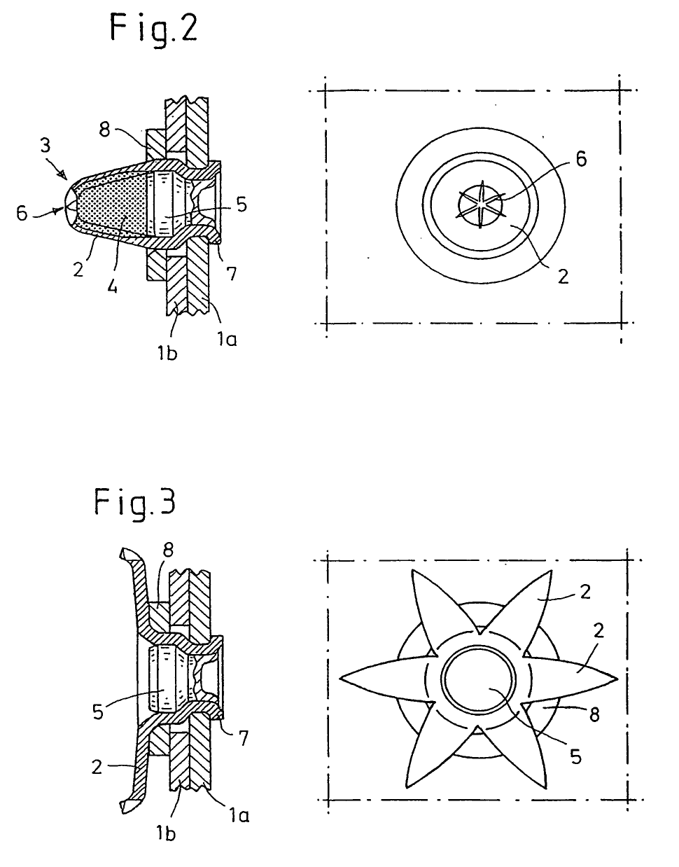

FIG. 2 (exemplary embodiment 1) shows the fastening element in accordance with the invention, pre-assembled on a partition-plate sheet as the first structural part 1a and with a second structural part 1b slid on and a floating disc 8 as a counter-bearing. FIG. 3 shows the fastening element after the propellant charge 4 has been triggered, thereby resulting in riveting.

Function:

If after joining the sheet/structural-element parts the pyromechanical fastening element has a heat source (for example a laser) applied to it that acts in a punctiform manner and the power density of which is so high that it causes incandescence of the shell 2 in a punctiform manner, the propellant charge 4 is ignited. Depending on the type of pyrotechnic propellant charge, a rapid high pressure is generated in a temporally controlled manner. The pre-notched spreading elements of the shell 2 are accelerated greatly and bend around sharply in consequence of the specifically selected material. The previously loose connection is practically riveted. It can be advantageous, as shown in the example of FIG. 2 and FIG. 3, to use a so-called “floating disc” 8 as a counter-holder in order to use less exact joint parts too.

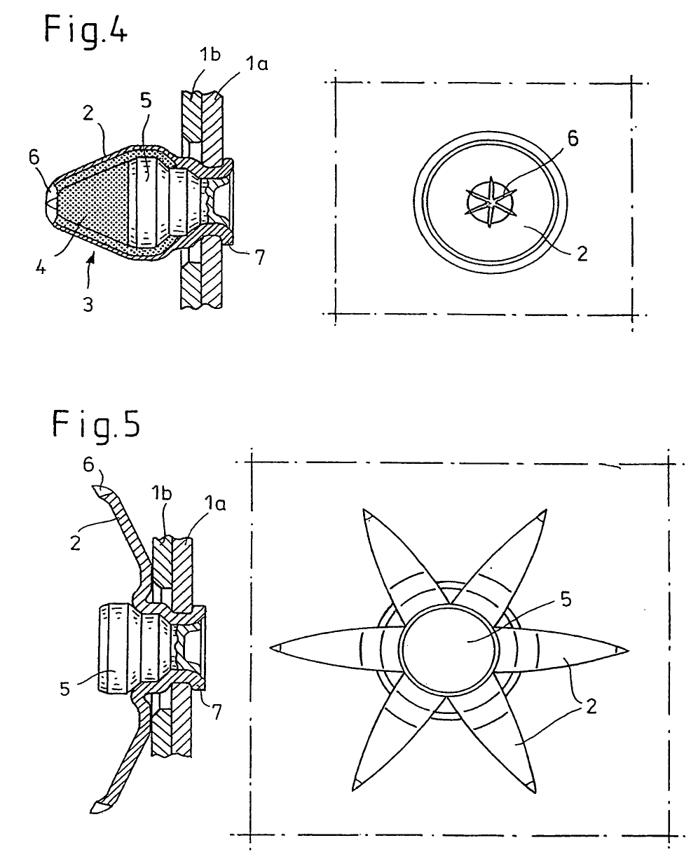

FIGS. 4 and 5 show the effect of the fastening element without a counter-holding disc.

1. Pyromechanical fastening element for mechanically connecting two structural parts in an unremovable and fixed manner, characerised in that the fastening element consists of a metallic shell, arranged in the head portion of which there is a pyrotechnic propellant charge that is adjacent to an adapter and arranged on the rear portion of the shell adjacently to the adapter there is a fastening means for a first structural party, and a second structural part can be slid on between the first structural part and the adapter, with the shell having at its head portion set fracture notches that extend in the longitudinal direction and rip open the shell when the propellant charge is ignited and can be bent around the adapter, thereby fixedly connecting the first structural part to the second structural part.

2. Fastening element according to claim 1, characterised in that the head portion of the shell is formed so that it is conical.

3. Fastening element according to claim 1, characterised in that the shell is produced using the deep-drawing process.

4. Fastening element according to claim 1, characterised in that the adapter is embedded in the shell with press fit.

5. Fastening element according to claim 1, characterised in that the pyrotechnic propellant charge can be ignited by means of a punctiform heat source.

6. Fastening element according to claim 5, characerised in that the heat source is a laser beam of a laser.

7. Fastening element according to claim 1, characterised in that the fastening means is a flanged edges.

8. Fastening element according to claim 1, characerised in that adjacently to the second structural part a floating disc is slid onto the adapter as a counter-bearing.
